(19) United States
(12) Patent Application Publication
(10) Pub. No.: US 2025/0263019 A1
(43) Pub. Date: Aug. 21, 2025

(54) MOTOR VEHICLE SUN VISOR PICTURE MOUNTING AND PROTECTIVE APPARATUS

(71) Applicant: ROBERT L CLEMENT, Goshen, CT (US)

(72) Inventor: ROBERT L CLEMENT, Goshen, CT (US)

(21) Appl. No.: 19/090,266

(22) Filed: Mar. 25, 2025

Related U.S. Application Data
(63) Continuation-in-part of application No. 18/443,320, filed on Feb. 16, 2024.

(51) Int. Cl. B60R 7/05

(52) U.S. Cl. CPC B60R 7/05

(57) ABSTRACT

Apparatus for mounting and protecting photos or documents positioned on the face of a motor vehicle sun visor which comprises a sleeve having a parallel projection of opposed edges spaced apart by a dimension sufficient to allow passage of the free end of the visor into the sleeve with this the sleeve and snug relationship with the visor.

### RELATED APPLICATIONS

This application is a continuation in part application U.S. application Ser. No. 18/443,320 filed on Feb. 16, 2024.

### BACKGROUND OF THE INVENTION

The present invention is generally directed to motor vehicle apparatus. More particularly, the present invention is directed to an improvement to sun visors employed on motor vehicles.

Many drivers as well as other occupants of motor vehicles carry memorable photos that illustrate various life experiences and memories that are highly valued. Similarly, many such occupants of motor vehicles may have continually changing to-do lists to ensure the most efficient sequential accomplishment of a plurality of goals for any given period. In other cases, the driver or passenger may need to have ready access to a given map, street name, house number or other information to accomplish particular tasks. The present invention is intended to enable simple mounting as well as protection of one or a plurality of photographs or other documents on the front or the back as well as on both sides of the sun visor in front of the driver and/or the front or the back of the sun visor in front of a passenger.

The prior art does not adequately facilitate preferable mounting and protecting such documents.

### SUMMARY OF THE INVENTION

The shortcomings of the prior art are overcome. Additional advantages are provided through apparatus for mounting and protecting photos or documents positioned on the face of a sun visor which comprises a sleeve having a parallel projection of opposed edges spaced apart edges sufficiently to allow passage of the free end of the visor into the sleeve with this the sleeve and snug relationship with the visor.

### BRIEF DESCRIPTION OF DRAWINGS

FIG. 1 is a partially schematic side view of a motor vehicle sun visor provided with one embodiment of the present invention.

FIG. 2 is a partially schematic side view of a motor vehicle sun visor provided with a similar embodiment of the present invention.

FIG. 3 illustrates an embodiment provided with ears on free end thereof secure the apparatus to vehicle visor.

FIG. 4 illustrates the ears in greater detail.

FIG. 5 is an exploded view further illustrating cooperation between the present invention in the existing visor structure.

### DETAILED DESCRIPTION OF THE INVENTION

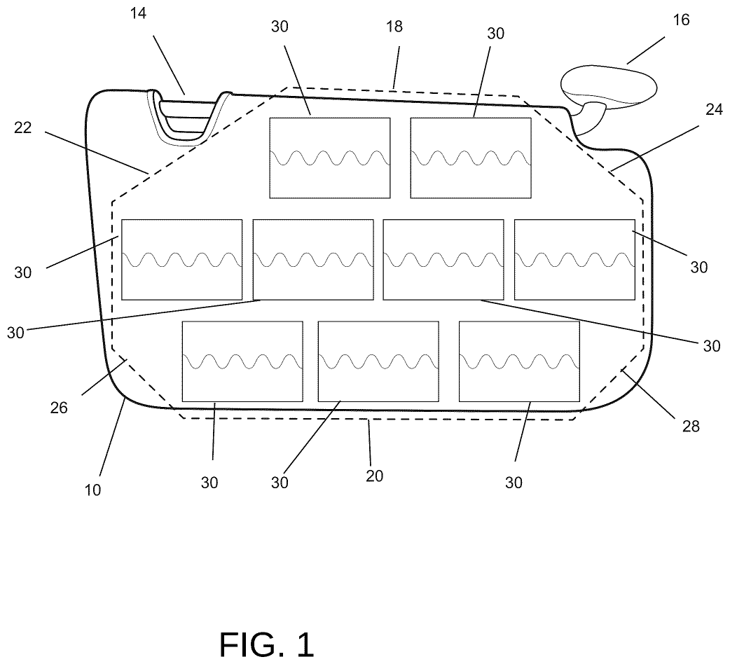

Referring now to FIG. 1 there is shown a typical motor vehicle sun visor 10 mounted by a pivot 16 which is attached to the body of the motor vehicle (not shown). The sun visor 10 further includes a mounting bar 14 that engages the motor vehicle (not shown). To illustrate the present invention the drawing includes only schematic representations of photos and/or other documents 30 disposed against one face of the sun visor 10. In some embodiments of the invention the photos will be mounted on a cardboard sheet. It will be understood that all faces of all sun visors in a given motor vehicle may have such photos and/or documents disposed on the faces thereof either with or without a cardboard mounting.

A transparent flexible sleeve is dimensioned and configured to be slid over the sun visor 10 from the free end as viewed side of the sun visor 10. It will be understood that the visor is typically anchored at the outboard edge thereof to the motor vehicle. Accordingly, the inboard edges of each visor is properly identified as the free and of the visor.

Typical embodiments of the sleeve of the present invention, in a simplest form, when visualized as a parallel projection has opposed parallel sides 18 and 20. A primary requirement of the embodiment is that the sleeve be dimensioned to have the edges 18 and 20 sufficiently far apart to allow placement of the sleeve over the visor 10. Thus, a parallel projection of that simplest form would be a rectangle. In some embodiments, the sleeve will secure the photos and/or other documents mounted a cardboard without the need for other adhesive.

To accommodate the complexities of providing for different visor shapes and mountings including the curved corners of the visor as well as the mounting bar 14 and pivot 16 more sophisticated embodiments of the present invention require more elaborate shapes.

As shown in the FIG. 1 the dashed line corresponding essentially to a parallel projection thereof has an oblique edge 22 to provide clearance with respect to the mounting bar 14 and an oblique edge 24 to provide clearance with respect to the pivot 16. Similarly, an oblique edge 26 avoids undesired overlap of the corner of the visor 10 in an oblique edge 28 also avoids undesired overlap of the corner of the visor 10.

In some embodiments of the present invention the plastic material of the sleeve may be more flexible or more rigid. An extremely flexible material may allow the use of a sleeve that has a rectangular parallel projection because the flexibility will not interfere with the operation of the support bar or the pivot or even be objectionable if it extends beyond the corners of the visor. In embodiments of the present invention with a plastic material for the sleeve that is more rigid, it is probable that the oblique surfaces 22, 24, 26, and 28 or equivalent contours will be necessary to avoid interference with the bar 14 or the pivot 16. The precise contours chosen are dependent on a somewhat conflicting design criteria of (a) providing a standardized design that is cheaper to produce in quantity and (b) a specialized design for a specific vehicle that will function better and be more aesthetically appealing.

Accordingly, as shown in the drawing the sleeve maintains a firm grip on the visor because of the contact with the edges 18 and 20. This firm grip enables the axial extremities of the sleeve, as viewed in the figure, to protect photos and/or other documents under the axial extremities of the sleeve.

For the purpose of description, it will be understood that the structure shown in the parallel projection figure identified by the reference numerals 22, 24, 26, and 28 may be referred to herein as cut offs of the sleeve.

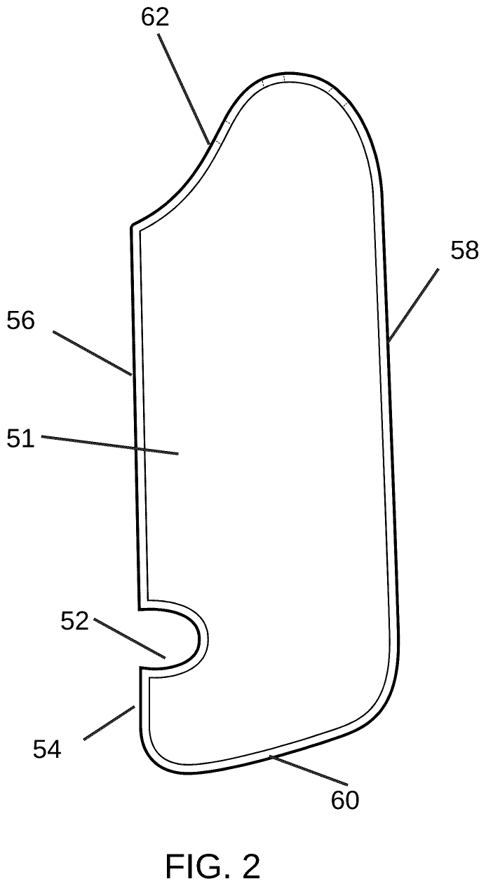

Referring now to FIG. 2, the apparatus includes a 1st planar side 51, having an arcuate portion 52 dimensioned and configured to provide clearance for this the original equipment factory visor mounting. A substantially identical 2nd planar side 70 is disposed in face to face abutting relationship to the 1st planar side 51. Typically, the edges 54, 56, 58, and 60 of the respective sides 51 and 70 are fixed together to define the sleeve that fits over the factory equipment visor. The axial extremities 62 of the planar sides 51 and 70 are not joined together to allow installation over the factory equipment visor.

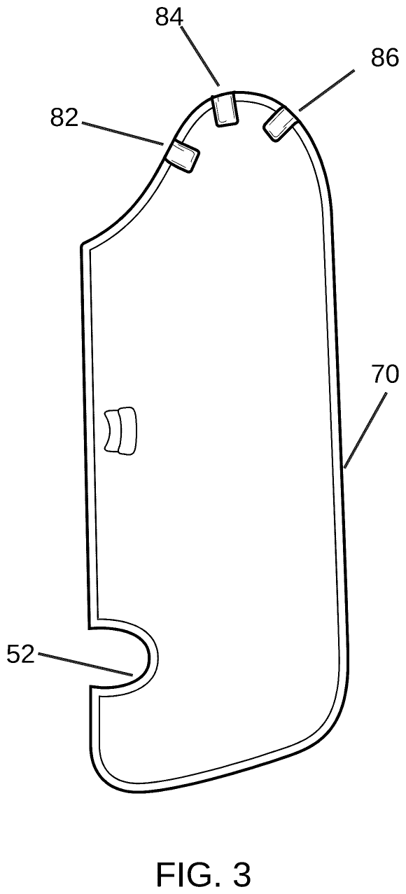

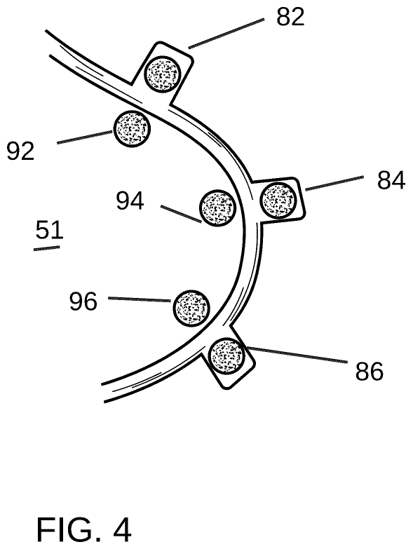

A primary difference between the sides 51 and 70 is that the side 70, best illustrated in FIG. 3 includes three ears 82, 84, and 86. As further shown in FIGS. 4, 18, 84, and 86 cooperating respectively with elements 92, 24, and 96. Cooperating hook and eye fastener pairs allow selective connection. Accordingly, when the respective pairs are engaged, a secure connection between the sides 51 and 70 is achieved.

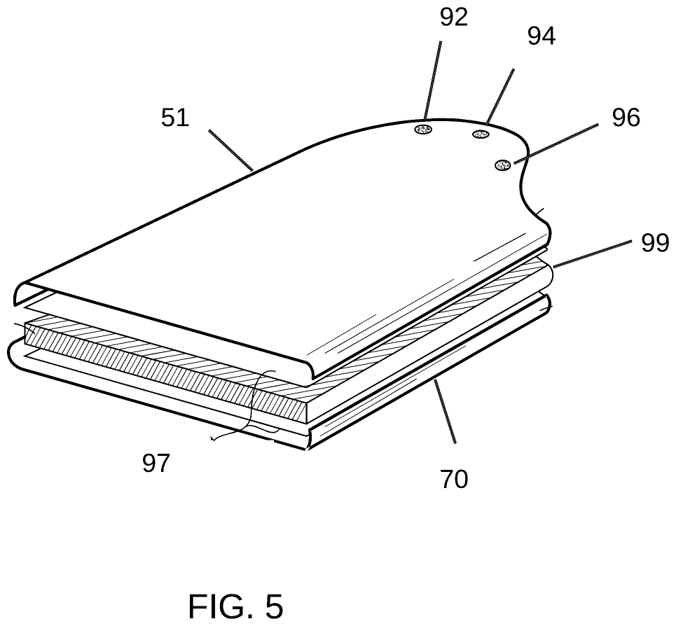

FIG. 5 illustrates the structure of the present invention in greater detail. More particularly, the original equipment visor 99 is illustrated between respective paper sheets 97. These sheets 97 are provided to facilitate users mounting, for example, favorite pictures, which will be visible through the transparent sides 51, 70. 2

All publications and patent applications mentioned in this specification are indicative of the level of skill of those skilled in the art to which this invention pertains. All publications and patent applications are herein incorporated by reference to the same extent as if each publication or patent application was specifically and individually indicated to be incorporated by reference.

It will be understood that, in general, terms used herein, and especially in the appended claims, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood that if a specific number of an introduced claim recitation is intended such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “an imager” should typically be interpreted to mean “at least one imager”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “two images,” or “a plurality of images,” without other modifiers, typically means at least two images). Furthermore, in those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A1, A2, and C together, A, B1, B2, C1, and C2 together, or B1 and B2 together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

While the invention has been described in terms of various specific embodiments, those skilled in the art will recognize that the invention can be practiced with modification within the spirit and scope of the claims. While certain embodiments of the invention have been illustrated and described, various modifications are contemplated and can be made without departing from the spirit and scope of the invention. Accordingly, it is intended that the invention is not to be limited, except as by the appended claim(s).

The teachings disclosed herein may be applied to other systems and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the present invention with which that terminology is associated. In general, the terms used in the following claims should not be constructed to limit the present invention to the specific embodiments disclosed in the specification unless the above description section explicitly defines such terms. Accordingly, the actual scope encompasses not only the disclosed embodiments but also all equivalent ways of practicing or implementing the disclosed present invention. The above description of embodiments of the present invention is not intended to be exhaustive or limited to the precise form disclosed above or to a particular field of usage.

While certain aspects of the present invention are presented below in particular claim forms, various aspects of the present invention are contemplated in any number of claim forms. Thus, the inventor reserves the right to add additional claims after filing the application to pursue such additional claim forms for other aspects of the present invention.

1. Apparatus for mounting and protecting photos or documents positioned on the face of an associated sun visor which comprises an elongated transparent sleeve having first and second sides and a first open axial extremity dimensioned and configured to allow passage of the free end of a vehicle's original equipment sun visor into the sleeve with the first and second sides in snug relationship with the visor and including at least one ear engaging both sides of the apparatus proximate to said open axial extremity to secure said sleeve to an associated sun visor.

2. Apparatus as described in claim 1 wherein said at least one ear is selectively secured to one of said sides by one part of a two-part cooperating hook and eye fastener pair.

3. Apparatus as described in claim 2 further including a second ear extending from one side of the apparatus to the other side of the apparatus proximate to said open axial extremity.

4. Apparatus as described in claim 3 wherein said second ear is selectively secured to one of said sides by one part of a two-part cooperating hook and eye fastener pair.

5. Apparatus as described in claim 4 further including a third ear extending from one side of the apparatus to the other side of the apparatus proximate to said open axial extremity.

6. Apparatus as described in claim 5 further including a third ear extending from one side of the apparatus to the other side of the apparatus.

7. Apparatus as described in claim 6 wherein said third ear is selectively secured to one of said sides by one part of a two-part cooperating hook and eye fastener pair.

8. The apparatus as described in claim 2 further including at least a layer of paper intermediate said sides for mounting associated visual displays.

9. The apparatus as described in claim 8 further including at least a second layer of paper intermediate said sides for mounting associated visual displays.
